(19) United States
(12) Patent Application Publication
(10) Pub. No.: US 2017/0351560 A1
(43) Pub. Date: Dec. 7, 2017

(54) SOFTWARE FAILURE IMPACT AND SELECTION SYSTEM

(71) Applicant: Microsoft Technology Licensing, LLC, Redmond, WA (US)

(72) Inventors: Ross Faulkner Smith, JR., Snoqualmie Pass, WA (US); Evan F. Goldring, Redmond, WA (US); Rajeev Dubey, Sammamish, WA (US); Harry Leo Emil, Redmond, WA (US); Amrita Ray, Palo Alto, CA (US)

(21) Appl. No.: 15/171,777

(22) Filed: Jun. 2, 2016

(51) Int. Cl. G06F 11/07

(52) U.S. Cl. CPC G06F 11/079; G06F 11/0706; G06F 11/0751

(57) ABSTRACT

Bugs/events that are reported by both users and the product are used to build an estimation model that relates the frequency/amount of received user bug reports to the number of products that are known to have the bug (as reported by the deployed products themselves.) This estimation model is then used to estimate the impact of bugs that are only discovered via user (i.e., free-form, unstructured) bug reports. In addition, the discovery of a bug via only user bug reports can be used to improve the data reported by the deployed products such that more information can be gathered about the nature and/or impact of the bug.

### BACKGROUND

Errors, mistakes, or omissions while writing software can cause unintended failures (or ‘bugs’) of the software and/or systems when they are deployed. These errors, bugs, and other faults in the software may not be noticed until the software has been deployed to a large number of users, or has been running for long periods of time. In addition, some of these errors and bugs may only exist in certain versions of the deployed software. This is particularly problematic for software that may be deployed on multiple platforms.

Take, for example, a software program that runs on desktop computers and handheld mobile devices (e.g., cell phones.) In this case, some bugs may be noticed only on the desktop version, some only on the mobile version, and some on both versions. The existence of these multiple versions in combination with multiple, possibly platform specific, bugs can make it difficult to prioritize which bugs to address first, how many resources should be allocated to fixing each respective bug, and which platform should be given priority.

### SUMMARY

Examples discussed herein relate to a method of detecting and tracking the impact of a software bug. This method includes receiving product information messages generated by instances of a software product. These product information messages include indicators used to associate each of the product information messages with at least one of a set of identified types of software bugs. These identified types of software bugs include at least a first type of software bug. Unstructured feedback messages are received from users of the software product. Based on these unstructured feedback messages, structured feedback indicators are generated for the unstructured messages. Based on the structured feedback indicators, a first subset of the unstructured feedback messages are mapped to respective ones of the identified types of software bugs. Also based on the structured feedback indicators, a second subset of the unstructured feedback messages that are not (or cannot be) mapped to one of the identified types of software bugs is determined. Based on the first subset and the second subset, a first indicator corresponding to the number of end users impacted by a second type of software bug that is not one of the identified of types of software bugs is generated.

In an example, a method of estimating software bug impacts on end users, includes deploying a plurality of instances of a software product. These plurality of instances include a multiple versions of the software product deployed across multiple of hardware platforms. Product information messages generated by the plurality of instances are received. These product information messages are associated with identified types of software bugs. These identified types of software bugs are dependent on a version of the software product that is associated with a hardware platform. These identified types of software bugs include at least a first type of software bug. Unstructured feedback messages about the software product are received. These unstructured feedback messages include at least one of a version indicator and/or hardware platform indicator. Based on the unstructured feedback messages, structured feedback indicators that include a version indicator are generated. Based on the structured feedback indicators, and based on the version indicator, a subset of the unstructured feedback messages are mapped to respective ones of the identified types of software bugs. Also based on respective structured feedback indicators, and based on the version indicator, it is determined that a new type of software bug is to be included in the plurality of types of software bugs. Based on the subset, a first indicator corresponding to the number of end users impacted by the new type of software bug is generated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 is a block diagram illustrating a deployed software system with bug discovery and impact forecasting.

FIG. 2 is a flowchart illustrating a method of estimating the number of impacted users.

FIG. 3 is a diagram illustrating impacted user estimates.

FIG. 4 is a flowchart illustrating a method of estimating the impact of a bug from free-form user feedback.

FIG. 5 is a flowchart illustrating a method of estimating the impact of a version and/or platform correlated bug.

FIG. 6 is a block diagram of a computer system.

### DETAILED DESCRIPTION OF THE EMBODIMENTS

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure.

Feedback that indicates a software bug or other failure of a system can be received both from users and from the product itself. For example, users may complain about a bug in a product via social media, or via a support web page. The product itself may generate and send product information messages (e.g., crash reports, core dumps, or product telemetry) to a central reporting/tracking system. Typically, the user feedback is free-form (i.e., unstructured), and the product generated information is already structured (and/or formatted) by the program. In some embodiments, the product generated information may also include free-form user input.

With the bug feedback information available from two sources, three situations can occur: (i) the product reports the bug/event but there are no user reports of the bug/event; (ii) users are reporting a bug/event but there are no reports from the deployed products detailing the bug; and, (iii) the bug/event is reported by both users and the product itself. In an embodiment, bugs/events that are reported by both users and the product are used to build an estimation model that relates the frequency/amount of received user bug/event reports to the number of products that are known to have the bug (as reported by the deployed products themselves.) This estimation model is then used to estimate the impact of bugs that are only discovered via user (i.e., free-form, unstructured) bug reports. In addition, the discovery of a bug via only user bug reports can be used to improve the data reported by the deployed products such that more information can be gathered about the nature and/or impact of the bug.

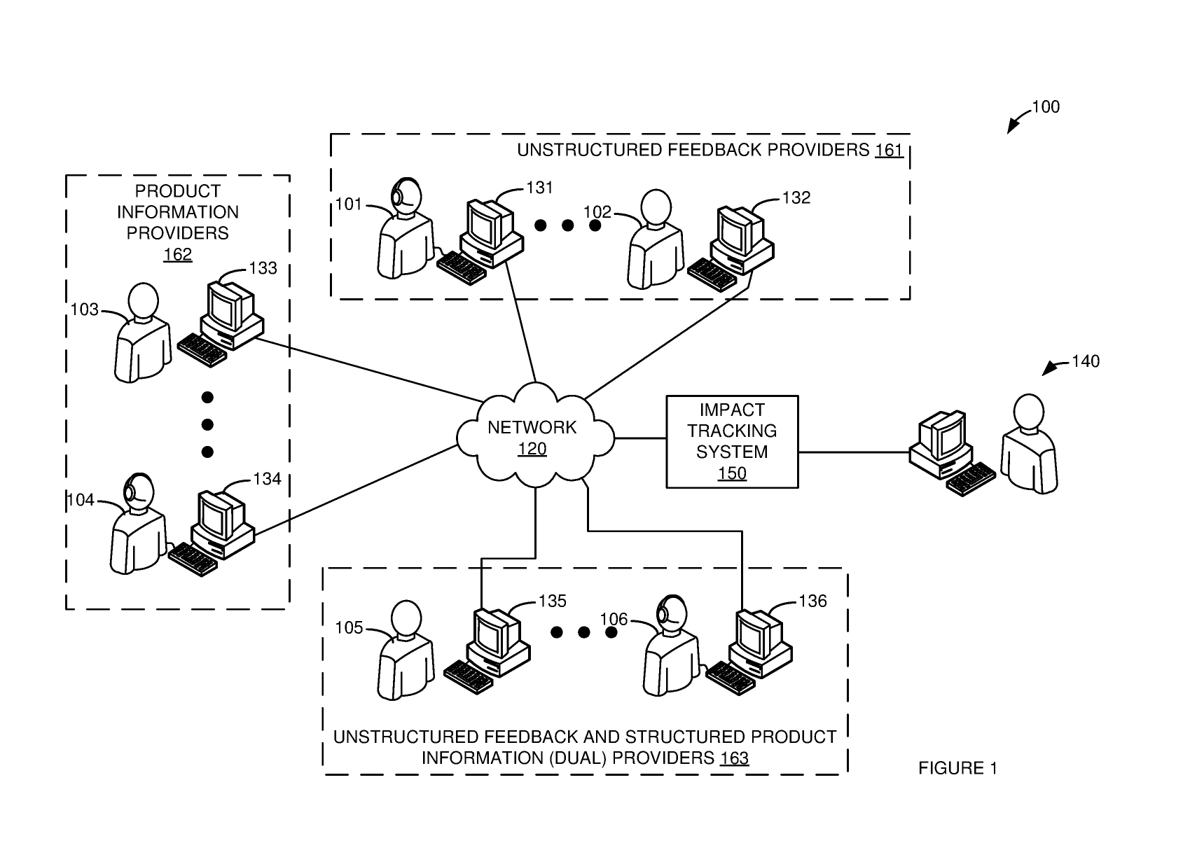

FIG. 1 is a block diagram illustrating a deployed software system with bug discovery and impact forecasting. In FIG. 1, deployed software system 100 comprises end users 101-106, computers 131-136, network 120, impact tracking system 150, and software debugger/manager 140. Users 101-106 use a software program deployed on computers 131-136, respectively. Computers 131-136 are operatively coupled to network 120. Network 120 is operatively coupled to impact tracking system 150. Debugger/manager 140 may access impact tracking system 150.

Computers 131-136 under the control of users 101-106 may execute a deployed software program being monitored by impact tracking system 150. This program may have errors, bugs, or lack features that one or more users 101-106 may desire. When an error in the program manifests itself, the user 101-106, the program, or both may provide feedback regarding the error (or perceived error) to impact tracking system 150. Typically, this feedback will be provided to impact tracking system 150 via network 120 and computers 131-136.

Typically, a software bug is an error, flaw, failure or fault in a computer program or system that causes the program or product to produce an incorrect result, unexpected result, or to otherwise function in unintended ways. Mistakes and errors made by people in any one of a program's source code, design, framework, and/or similar mistake or errors in the operating systems used by such programs are the usual cause of bugs. Structured reports detailing bugs in a program are commonly known as bug reports, defect reports, fault reports, problem reports, trouble reports, change requests, and the like.

Network 120 is a wide area communication network that can provide wired and/or wireless communication with impact tracking system 150 by computers 131-136. Network 120 and can comprise wired and/or wireless communication networks that include processing nodes, routers, gateways, physical and/or wireless data links for carrying data among various network elements, including combinations thereof, and can include a local area network, a wide area network, and an internetwork (including the Internet). Network 120 can also comprise wireless networks, including base station, wireless communication nodes, telephony switches, internet routers, network gateways, computer systems, communication links, or some other type of communication equipment, and combinations thereof. Wired network protocols that may be utilized by network 120 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Links between elements of network 120, can be, for example, twisted pair cable, coaxial cable or fiber optic cable, or combinations thereof.

Other network elements may be present in network 120 to facilitate communication but are omitted for clarity, such as base stations, base station controllers, gateways, mobile switching centers, dispatch application processors, and location registers such as a home location register or visitor location register. Furthermore, other network elements may be present to facilitate communication between among elements of deployed software system 100 which are omitted for clarity, including additional computing devices, client devices, access nodes, routers, gateways, and physical and/or wireless data links for carrying data among the various network elements.

In FIG. 1, users 101-102 use computers 131-132 to provide unstructured (e.g., free-form natural language comments) user feedback about the deployed software product. Users 101-102 and their associated computers 131-132 will be collectively referred to herein as unstructured feedback providers 161. Examples of unstructured feedback provided by unstructured feedback providers 161 include, but are not limited to, when users 101-102 log into a support site or post a comment to social media complaining of the error, or a bad user experience. In an embodiment, impact tracking system 150 may actively monitor social media for comments about the software product. This monitoring of social media for unstructured feedback messages may include, but is not limited to, obtaining and parsing the contents of blogs, business networks, enterprise social networks, forums, microblogs, photo sharing, products/services review, social bookmarking, social gaming, social networks, video sharing, and virtual worlds. Thus, the monitoring of these sources for unstructured feedback messages provides a way for users 101-102 and 105-106 to indirectly provide unstructured feedback messages to impact tracking system 150 via network 120 (either via computers 131-132 and 135-136, or via another device not running the software product.) These unstructured user feedback messages may also be sent directly to impact tracking system 150 using computers 131-132 and network 120.

Computers 133-134 may provide, in response to the software program, structured product information messages. This structured product information may include, for example, debug or product telemetry messages. Users 103-104 and their associated computers 133-134 will be collectively referred to herein as product information providers 162. Structured product information messages may include product telemetry/information messages (or events) at are sent by devices (e.g., desktop mobile devices that have the software product—for example, the Skype™ app from Microsoft).

For example, when a first device (e.g., computer 131) places a Skype™ audio call to a second device (e.g., computer 132), then the first device will send an event/message with information on the date/time of the call start & end, (unidentified or obscured) user ids, device type and/or software version(s) of the parties to the call (e.g., computer 131 is a Windows™ desktop, and computer 132 is a mobile phone running a different operating system), etc. If the call fails, then additional information is received by impact tracking system 150. For example, when a call fails, impact tracking system may receive an indicator of the call failure reason (e.g., bad network, out of range etc.).

In an embodiment, the product information messages may be only a sample (or subset) of all the product information messages. This may be because not all devices (or software versions) send event/product information messages. Thus, if impact tracking system 150 observes from the product information messaging that, for example, 10 calls failed out of 100 calls this week, it may actually be that 20 calls failed out of 120 total calls. This may be a result of only a subset (or sample) of devices sending product information message. Thus, impact tracking system 150 estimation of the the total impacted customer population from both product information messaging and unstructured text feedback helps impact tracking system 150 provide better estimates.

For example exact telemetry/product information messages regarding events (though sampled in number) include, but are not limited to: messages sent, login attempts, app crashes, and location sharing in Instant Messaging. Other events, such as whether a caller can see other person clearly in a video call, or whether a user wants to delete profile, are not captured by exact product information messages regarding these events. By using the combination of data sources (i.e., structured and unstructured) impact tracking system 150 is able to estimate the number of affected customers in presence and/or absence of exact product information and in presence and/or absence of customer text feedback.

As an example, when the software program (or other monitoring program such as the operating system) detects a problem, computers 133-134 may be controlled to send a product information message (e.g., crash report) to impact tracking system 150 via network 120. In another example, ongoing information about the software product, or its functioning may be regularly provided by product information providers 162. This ongoing information may relate to, for example, the network activities of the product or other regular correspondence by the product (e.g., open socket, mount network disk, connect VoIP call, etc.)

Users 105-106 and computers 135-136 may both detect the error. In this case, both unstructured feedback and structured product information messages are sent by computers 135-136 to impact tracking system 150 via network 120. Thus, users 105-106 and their associated computers 135-136 will be collectively referred to herein as dual (i.e., structured and unstructured) message providers 163.

In an embodiment, impact tracking system 150 applies machine learning and/or statistical techniques to estimate the number of users 101-106 impacted by a given type of product bug. Impact tracking system 150 also predicts the impact in following weeks if the bug has not been fixed. Impact tracking system 150 estimates the population impact by using Poisson and Binomial proportion such that a 95% confidence interval around the estimates is also provided. Impact tracking system 150 assumes that for small to moderate numbers of users 101-102 and 105-106 sending unstructured feedback messages about a given type of bug, the number of users 101-102 and 105-10 sending these unstructured feedback messages will follow a Poisson distribution over a given time period (e.g., a week). When there are a high number of users 101-102 and 105-106 sending unstructured feedback messages, impact tracking system 150 assumes the arrival of these unstructured feedback messages follows a Binomial distribution. In both cases, impact tracking system 150 uses the sample proportion (i.e., the sample is those users/computers sending unstructured messages) as maximum likelihood estimators (best estimates) of the population proportions. Impact tracking system 150 uses a Normality assumption for the confidence intervals.

Impact tracking system 150 predicts of the impact of a given type of bug by applying moving average to the number of weekly active users 101-106, and the estimated proportion of users 101-106 experiencing the problem. The number of weekly active users typically follows a significant weekly trend. Therefore, impact tracking system 150 does not use linear regression to predict the activity or the number of affected users. Impact tracking system 150 uses a moving average. Impact tracking system 150 predicts the number of affected users as the product of predicted number of active users and the estimated proportion facing problem.

Impact tracking system 150 estimates the impact of a given type of bug where structured feedback is not present from the rate of customer feedback received from unstructured feedback providers 161. Where, for a given type of bug, impact tracking system 150 receives only product information messages (i.e., only receives messages about this bug from product information providers 162), but this type of bug is not mentioned in unstructured user feedback received from either unstructured feedback providers 161 or dual feedback message providers 163, impact tracking system 150 estimates the impact based on the messages from product information providers 162. This helps impact tracking system 150 assess the performance of new releases before users 101-106 complain about poor experiences (and therefore become unstructured feedback providers 161 and/or dual feedback providers 163).

For example, impact tracking system may:
a) Convert customer unstructured feedback from unstructured feedback providers 161 and dual feedback providers 163 to verb-noun pairs in engineering terminology.
b) Build or receive a metonym connection between the verb-noun pairs and the content of messages from product information providers 162 and/or dual feedback providers 163. For example: unstructured customer feedback messages from unstructured feedback providers 161 and dual feedback providers 163 containing verb “Send” and noun “Message” are mapped to the contents of product information messages received from product information providers 162 and the product information messages from dual feedback providers 163.
c) Define the events to measure with the product information messages from product information providers 162 and dual feedback providers 163. For example, a message attribute (e.g., failure to send message) is measured from the product information messages from product information providers 162 and dual feedback providers 163. In some cases, the exact event in the product information messages from product information providers 162 and dual feedback providers 163 may not be present or identifiable.
d) Measure the impact of an engineering/software bug on the population of users 101-106 (or computers 131-136). For example, the percentage of weekly active users 101-106 with attributes associated with VoIP calling can be an estimate of the number of users 101-106 affected by the example messaging problem. Impact tracking system sample estimates of binomial proportion and large sample confidence intervals are used to provide this estimate with a confidence interval. The estimated proportion can be multiplied by the active users 101-106 to calculate an estimate of the impacted users 101-106 in that week.
e) Project the impact of the type of bug in one or more future time periods. For example, impact tracking system may calculate the percentage of users 101-106 that will still experience the example messaging problem in following weeks if the bugs are not fixed. Impact tracking system 150 may use a moving average technique calculate the projected number (or percentage) of impacted users 101-106.
f) Build a list of bugs where the contents of product information message from product information message providers 162 and dual feedback providers 163 is absent and/or not received. For example, deletion or corruption of a critical file may not result in product information messages being received from product information message providers 162 and dual feedback providers 163.
g) Estimate the impact in the absence of product telemetry. For example, structured feedback “See+Contact” from 161 may not be mapped to the content of product information messaging from either from product information message providers 162 or dual feedback providers 163. Impact tracking system 150 may use Poisson estimation to measure and predict the number of users 101-106 affected by the rate of feedback of that topic per week.
h) Build a list of deduced feedback for possible bugs from failed events in product information messaging from product information message providers 162 and dual feedback providers 163. For example, the contents of product information messaging from product information message providers 162 and dual feedback providers 163 may not capture the failure of location sharing while sending an instant message. However, the customers on, e.g., Android phones have not (yet) complained about this bug yet. Thus, impact tracking system 150 may, based on the product information messaging, select or deduce, for example, verb-noun pairs that are likely to correspond to the bug. By selecting, deducing, or anticipating attributes (e.g., verb-noun pair) of the unstructured feedback that will likely be associated with a particular bug allows impact tracking system 150 to provide earlier and better information and/or impact estimation. Furthermore, selecting, deducing, or anticipating attributes (e.g., verb-noun pair) of the unstructured feedback that will likely be associated with a particular bug allows impact tracking system 150 to provide impact estimation about platforms and/or software versions that have not been sending structured feedback messages.

In an embodiment, impact tracking system 150 receives product information messages from product information message providers 162 and dual feedback providers 163 that are generated by instances of the software product running on computers 133-136. The contents of these product information messages from product information message providers 162 and dual feedback providers 163 allow impact tracking system 150 to associate these message with at least one of an identified type of bug (e.g., crash, call fail, blue screen, etc.) Impact tracking system 150 also receives unstructured user feedback messages from unstructured providers 161 and dual feedback providers 163.

Based on the unstructured feedback messages (i.e., from unstructured providers 161 and dual feedback providers 163), impact tracking system 150 generates structured feedback indicators. These structured feedback indicators may be verb-noun pairs. Based on these generated structured feedback indicators, impact tracking system 150 respectively maps a subset of the received messages each to one of the (previously) identified types of bugs. Also based on the unstructured feedback messages (i.e., from unstructured providers 161 and dual feedback providers 163), impact tracking system 150 determines that at least some (i.e., another subset) of the received messages cannot be mapped to any of the identified types of bugs.

Based on the successfully mapped messages, and the unsuccessfully mapped message, impact tracking system 150 generates an estimate corresponding to the number of users 101-106 impacted by at least one previously unidentified type of bug. For example, based on a correlation between the number of unstructured user messages received from users 105-106 to the number of actual problems experienced (as determined from the product information messages from computers 135-136) a ratio of actual problems experienced to user complaints can be calculated. This ratio can then be applied to determine how many of users 101-102 (where product information messages are not being sent and/or don't have adequate contents) are impacted by a bug. The calculated ratio, and/or the number of users 101-102 may also be based on product version information received by impact tracking system 150 from computers 131-132.

In an embodiment, impact tracking system 150 may receive product information messages from computers 130-136. These product information messages may come from multiple different versions of the software, and/or multiple different hardware platforms. Typically, different hardware platforms require different versions of the software. Impact tracking system 150 associates the product information messages with identified bugs that are version dependent.

Impact tracking system 150 also received unstructured feedback messages where the user 101-106 mentions either the hardware platform or the software version that experienced the bug. Based on the unstructured feedback messages (i.e., from unstructured providers 161 and dual feedback providers 163), impact tracking system 150 generates structured feedback indicators that include information about the software version. These structured feedback indicators may include verb-noun pairs. Based on these generated structured feedback indicators, and based on the software version information, impact tracking system 150 respectively maps a subset of the received messages each to one of the (previously) identified types of bugs. Also based on the unstructured feedback messages (i.e., from unstructured providers 161 and dual feedback providers 163), and based on the software version information, impact tracking system 150 determines that at least some (i.e., another subset) of the received messages cannot be mapped to any of the identified types of bugs and therefore qualify as a new (i.e., previously unidentified) bug that should be mapped.

Based on the successfully mapped messages, impact tracking system 150 generates an estimate corresponding to the number of users 101-106 impacted by the new bug. For example, based on a correlation between the number of unstructured user messages received from users 105-106 to the number of actual problems experienced (as determined from the product information messages from computers 135-136) a ratio of actual problems experienced to user complaints about a new bug can be calculated. This ratio can then be applied to determine how many of users 101-102 (where product information messages are not being sent and/or don't have adequate contents) are impacted by a new bug.

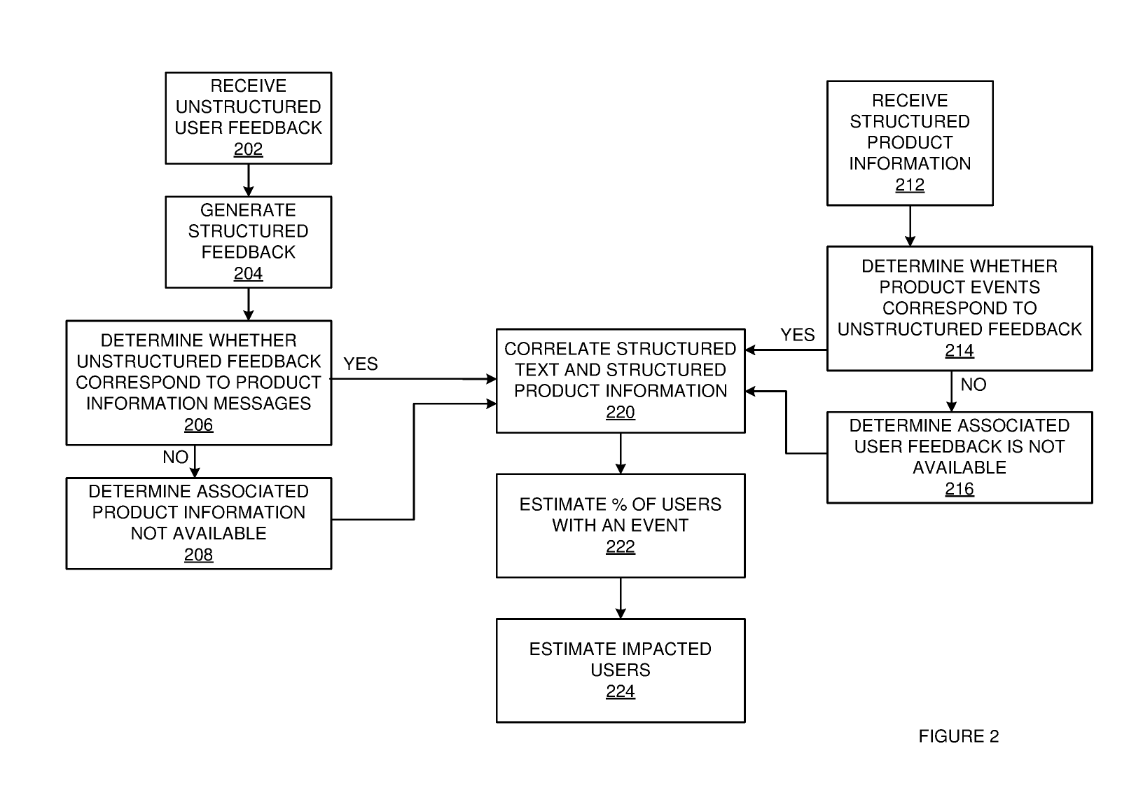

FIG. 2 is a flowchart illustrating a method of estimating the number of impacted users. The steps illustrated in FIG. 2 may be performed by one or more elements of deployed software system 100. Flow for unstructured feedback begins in box 202. Flow for structured product information begins in box 212.

Unstructured feedback is received (202). For example, unstructured free-form text feedback may be received from unstructured providers 161 and dual feedback providers 163. Structured feedback is generated from the unstructured feedback (204). For example, impact tracking system 150 may generate verb-noun pairs corresponding to each of the unstructured feedback messages received from unstructured providers 161 and dual feedback providers 163.

It is determined whether the unstructured feedback corresponds to product information messages (206). For example, the structured feedback generated in step 202 may be associated with either an already identified type of bug that is being tracked using product information messages, or may indicate a new type of bug where there is little or no corresponding product information messaging. If the unstructured feedback corresponds to product information messages, flow proceeds to block 220. If it is determined that the unstructured feedback does not correspond to product information messages, flow proceeds to block 208.

It is determined that associated product information is not available (208). For example, for a new type of bug, impact tracking system 150 may determine that the product information messaging impact tracking system 150 is receiving is inadequate to estimate the impact using product information messages alone. Flow proceeds from block 208 to block 220.

Structured product information is received (212). For example, product information messages may be received from product information message providers 162 and/or dual feedback providers 163. It is determined whether the product information messages correspond to unstructured feedback messages (214). For example, the received product information messages may be associated with either an already identified type of bug that is being tracked using unstructured feedback messages, or may indicate a new type of bug where there is little or no corresponding unstructured feedback messaging. If the product information messages correspond to unstructured messages, flow proceeds to block 220. If it is determined that the product information messages do not correspond to unstructured feedback messaging, flow proceeds to block 216.

It is determined that associated user feedback information is not available (216). For example, for a new type of bug, impact tracking system 150 may determine that the product information messaging impact tracking system 150 is receiving indicates a bug that users have not yet started complaining about. Flow proceeds from block 216 to block 220.

Structured text and structured product information are correlated (220). For example, based on a correlation between the number of unstructured user messages received from users 105-106 to the number of actual problems experienced (as determined from the product information messages from computers 135-136) a ratio of actual problems experienced to user complaints can be calculated.

The percentage of users with an event is estimated (222). For example, the ratio of actual problems experienced to user complaints/sugggestions/perceptions where there is no product information messaging (e.g., because of a lack of product information messaging in a particular version or for a particular hardware platform), and/or as the number of affected users as reported by product information messaging (which can also report the particular version and/or particular hardware platform experiencing the problem) can be combined to calculate a percentage of users affected by a bug and/or percentage of users with a certain product functionality (e.g., user perception of quality/speed/etc., and/or user suggestion for features/functionality).

The number of impacted users is estimated (224). For example, the percentage of users affected can be used in combination with a weekly usage pattern (i.e., of number of users of the program or number of users activating a certain feature/bug) to estimate the number of affected users. In addition, the number of impacted users for future time periods can be estimated.

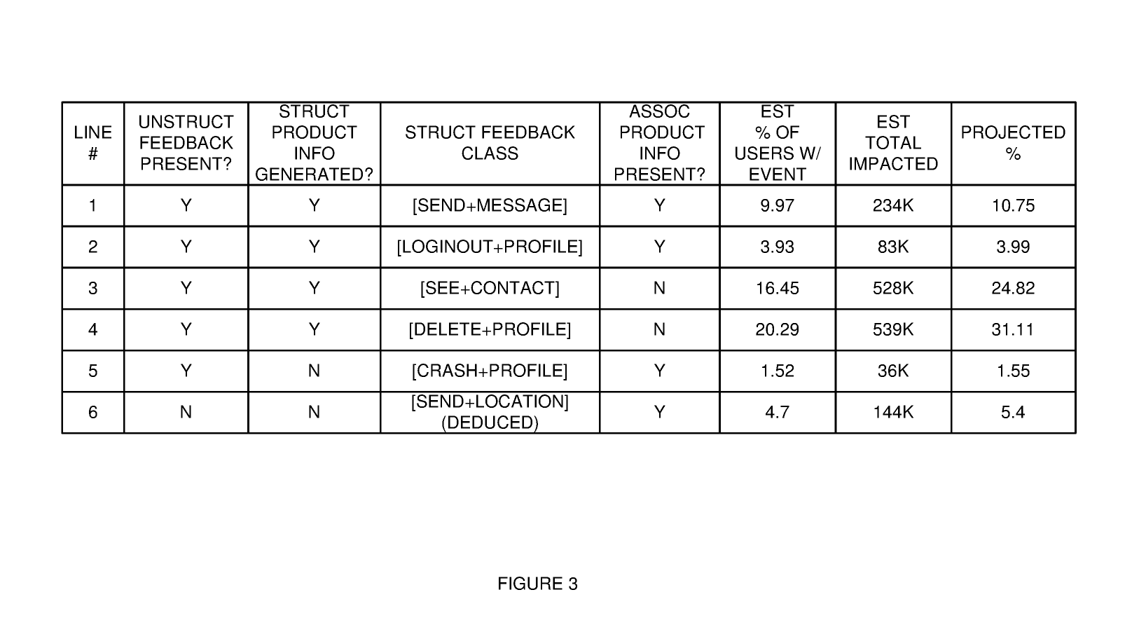

FIG. 3 is a diagram illustrating impacted user estimates. FIG. 3 can be an example of the output made by impact tracking system 150 and presented to and software debugger/manager 140. The output made by impact tracking system 150 and presented to and software debugger/manager 140 may be used by software debugger/manager 140 to, for example, prioritize the fixing of bugs and/or improvement of the functioning of the software product and/or computers 131-136.

FIG. 3 is a table of an example output by impact tracking system 150 with six lines and eight columns. Each of the six lines corresponds to an identified bug. The columns correspond to: (i) whether unstructured feedback was present; (ii) whether structured feedback has been generated; (iii) the classification of the structured feedback (i.e., type of bug); (iv) whether product information messages associated with this bug is being received; (v) the estimate percentage of users that are experiencing the bug/event over the current time period (e.g., this week); (vi) the estimated total number of users impacted; and, (vii) the projected percentage of users that will be affected over a selected time period (e.g., next week) in the future.

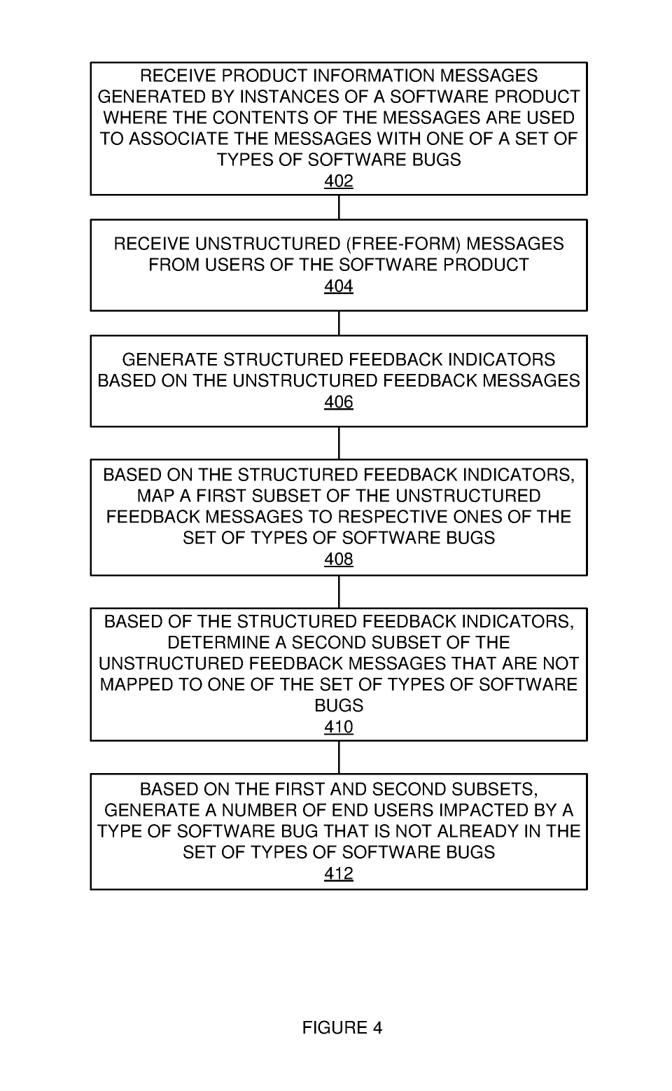

FIG. 4 is a flowchart illustrating a method of estimating the impact of a bug from free-form user feedback. The steps illustrated in FIG. 4 may be performed by one or more elements of deployed software system 100. Product information messages generated by instances of a software product where the contents of the message are used to associate the messages with one of a set of types of software bugs are received (402). For example, impact tracking system 150 may receive structured product information messages from product information message providers 162 and/or dual feedback providers 163. The contents of these product information messages may be used by impact tracking system 150 to associate these messages with bugs that impact tracking system 150 is measuring and/or forecasting.

Unstructured (free-form) messages from users of the software product are received (404). For example, impact tracking system 150 may receive unstructured customer feedback messages from unstructured feedback providers 161 and dual feedback providers 163. Structured feedback indicators are generated based on the unstructured feedback messages (406). For example, impact tracking system 150 may convert customer unstructured feedback from unstructured feedback providers 161 and dual feedback providers 163 to verb-noun pairs in engineering terminology.

Based on the structured feedback indicators, a first subset of the unstructured feedback messages are mapped to respective ones of the set of types of software bugs (408). For example, the verb-noun pairs generated in box 406 may be used to classify the message to a type of bug (e.g., “Send+Message”) being experienced by other users.

Based on the structured feedback indicator, a second subset of the unstructured feedback messages that are not mapped to one of the set of types of software bugs (410). For example, a verb-noun pair generated in box 406 may not correspond to verb-noun or product information message reported bugs being experienced by other users—thereby indicating a new bug.

Based on the first and second subsets, a number of end users impacted by a type of software bug that is not already in the set of types of software bugs is generated (412). For example, based on a correlation between the number of unstructured user messages received from users 105-106 to the number of actual problems experienced (as determined from the product information messages from computers 135-136) a ratio of actual problems experienced to user complaints can be calculated. This ratio can then be applied to determine how many of users 101-102 are impacted by the new bug where there is no product information messaging. The calculated ratio, and/or the number of users 101-102 may also be based on product version information received by impact tracking system 150 from computers 131-132.

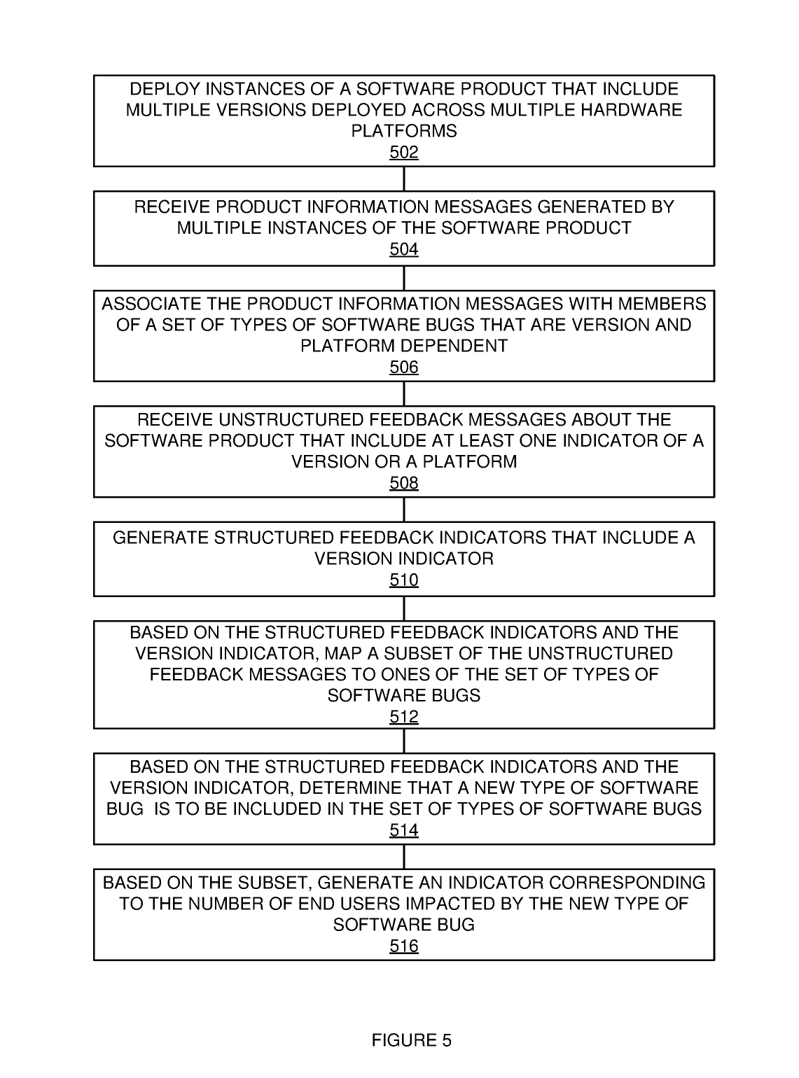

FIG. 5 is a flowchart illustrating a method of estimating the impact of a version and/or platform correlated bug. The steps illustrated in FIG. 5 may be performed by one or more element of deployed software system 100. Instance of a software product that include multiple versions are deployed across multiple hardware platforms (502). For example, multiple versions of a software product may be deployed to computers 131-136 where computers 131-136 comprise multiple hardware platforms (e.g., laptop, desktop, PDA, tablet, etc.)

Product information messages generated by multiple instances of the software product are received (504). For example, impact tracking system 150 may receive structured product information messages (a.k.a., telemetry) from product information message providers 162 and/or dual feedback providers 163. The product information messages are associated with members of a set of types of software bugs that are version and platform dependent (506). For example, impact tracking system 150 may parse the product information messages from product information message providers 162 and/or dual feedback providers 163 to classify each message according to a known bug list, and according to product version and hardware platform.

Unstructured feedback messages about the software product that include at least one indicator of a version or platform are received (508). For example, impact tracking system 150 may receive free-form messages in text format from unstructured providers 161 and dual feedback providers 163. These messages in text format may include mention of the hardware platform and/or software version (e.g., “The new version of ‘checkers’ crashed on my new Windows™ phone!”)

Structured feedback indicators that include a version indicator are generated based on the unstructured feedback messages (510). For example, impact tracking system 150 may convert customer unstructured feedback from unstructured feedback providers 161 and dual feedback providers 163 to verb-noun pairs in engineering terminology (e.g., ‘crash+Windows, phone, checkers v2.0’)

Based on the structured feedback indicators and the version indicator, a subset of the unstructured feedback messages are mapped to respective ones of the set of types of software bugs (512). For example, the verb-noun pairs generated in box 510 may be used to classify the message to a type of bug (e.g., “crash+Windows, phone, checkers v1.7”) being experienced by other users.

Based on the structured feedback indicators and the version indicator, determine that a new type of software bug is to be included in the set of types of software bugs (514). For example, if impact system 150 cannot may a particular verb-noun pair to the existing set of verb-noun pairs associated with identified bugs, impact tracking system 150 may decide that a new type of bug should be tracked (e.g., a new bug associated with ‘crash+Windows, phone, checkers v2.0’ should be included and tracked as a new bug—versus ‘crash+Windows, phone, checkers v1.7’ which is an already identified bug in version 1.7).

Based on the subset, generate an indicator corresponding the number of end users impacted by the new type of software bug (516). For example, based on a correlation between the number of unstructured user messages received from users 105-106 to the number of actual problems experienced (as determined from the product information messages from computers 135-136) a ratio of actual problems experienced to user complaints can be calculated. This ratio can then be applied to determine how many of users 101-102 are impacted by the new bug where there is no product information messaging. The calculated ratio, and/or the number of users 101-102 may also be based on product version information received by impact tracking system 150 from computers 131-132.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of deployed software system 100 and its components. These software descriptions may be: behavioral, register transfer, logic component, transistor, and layout geometry-level descriptions.

Data formats in which such descriptions may be implemented are stored on a non-transitory computer readable medium include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Physical files may be implemented on non-transitory machine-readable media such as: 4 mm magnetic tape, 8 mm magnetic tape, 3½-inch floppy media, CDs, DVDs, hard disk drives, solid-state disk drives, solid-state memory, flash drives, and so on.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

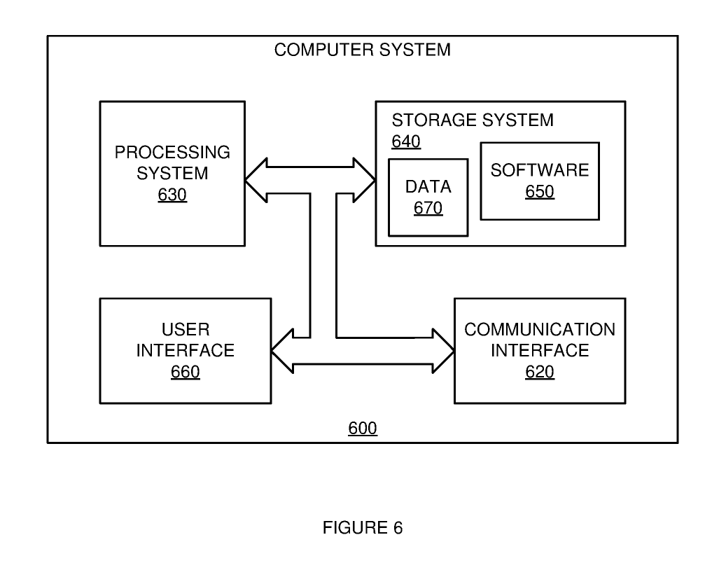

FIG. 6 illustrates a block diagram of an example computer system. Computer system 600 includes communication interface 620, processing system 630, storage system 640, and user interface 660. Processing system 630 is operatively coupled to storage system 640. Storage system 640 stores software 650 and data 670. Processing system 630 is operatively coupled to communication interface 620 and user interface 660. Computer system 600 may comprise a programmed general-purpose computer. Computer system 600 may include a microprocessor. Computer system 600 may comprise programmable or special purpose circuitry. Computer system 600 may be distributed among multiple devices, processors, storage, and/or interfaces that together comprise elements 620-670.

Communication interface 620 may comprise a network interface, modem, port, bus, link, transceiver, or other communication device. Communication interface 620 may be distributed among multiple communication devices. Processing system 630 may comprise a microprocessor, microcontroller, logic circuit, or other processing device. Processing system 630 may be distributed among multiple processing devices. User interface 660 may comprise a keyboard, mouse, voice recognition interface, microphone and speakers, graphical display, touch screen, or other type of user interface device. User interface 660 may be distributed among multiple interface devices. Storage system 640 may comprise a disk, tape, integrated circuit, RAM, ROM, EEPROM, flash memory, network storage, server, or other memory function. Storage system 640 may include computer readable medium. Storage system 640 may be distributed among multiple memory devices.

Processing system 630 retrieves and executes software 650 from storage system 640. Processing system 630 may retrieve and store data 670. Processing system 630 may also retrieve and store data via communication interface 620. Processing system 650 may create or modify software 650 or data 670 to achieve a tangible result. Processing system may control communication interface 620 or user interface 660 to achieve a tangible result. Processing system 630 may retrieve and execute remotely stored software via communication interface 620.

Software 650 and remotely stored software may comprise an operating system, utilities, drivers, networking software, and other software typically executed by a computer system. Software 650 may comprise an application program, applet, firmware, or other form of machine-readable processing instructions typically executed by a computer system. When executed by processing system 630, software 650 or remotely stored software may direct computer system 600 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of detecting a software bug, comprising:
receiving product information generated by instances of a software product, the product information including indicators used to associate product information messages with at least one of plurality of types of software bugs, the plurality of types of software bugs including a first type of software bug;
receiving unstructured feedback messages from users of the software product;
based on the unstructured feedback messages, generating respective structured feedback indicators;
mapping, based on respective structured feedback indicators, a first subset of the unstructured feedback messages to respective ones of the plurality of types of software bugs;
determining, based on respective structured feedback indicators, a second subset of the unstructured feedback messages is not mapped to respective ones of the plurality of types of software bugs;
based on the first subset and the second subset, generating a first indicator corresponding to the number of end users impacted by a second type of software bug that is not one of the plurality of types of software bugs.

2. The method of claim 1, further comprising:
based on the first subset, generate a second indicator corresponding to the number of end users impacted by the first type of software bug.

3. The method of claim 1, wherein a first number of product information messages are associated with the first type of software bug and a second number of unstructured feedback messages are associated with the first type of software bug.

4. The method of claim 3, wherein an impact indicator that corresponds to the number of end users impacted by the first type of software bug is generated based on the first number and the second number.

5. The method of claim 1, wherein the structured feedback indicators comprise verb-noun pairs that are associated to one of a set of bug types comprising the plurality of types of software bugs and the second type of software bug.

6. The method of claim 2, wherein the plurality of instances comprises a plurality of versions of the software product that include a first version and a second version, and wherein the second indicator is further based on the number of instances of the first version that are deployed.

7. The method of claim 6, wherein the first version and the second version are executed on different hardware platforms.

8. The method of claim 1, wherein the unstructured feedback messages are received via social media.

9. A method of estimating software bug impacts on end users, comprising:
deploying a plurality of instances of a software product, the plurality of instances comprising a plurality of versions of the software product deployed across a plurality of hardware platforms;
receiving product information messages generated by the plurality of instances;
associating the product information messages with a plurality of types of software bugs, the plurality of types of software bugs being dependent on a version of the software product that is associated with a hardware platform, the plurality of types of software bugs including a first type of software bug;
receiving unstructured feedback messages about the software product, the unstructured feedback messages including at least one of a version indicator and hardware platform indicator;
based on the unstructured feedback messages, generating respective structured feedback indicators that include a version indicator;
mapping, based on respective structured feedback indicators and based on the version indicator, a subset of the unstructured feedback messages to respective ones of the plurality of types of software bugs;
based on respective structured feedback indicators and based on the version indicator, determining a new type of software bug to include in the plurality of types of software bugs;
based on the subset, generate a first indicator corresponding to the number of end users impacted by the new type of software bug.

10. The method of claim 9, further comprising:
based on the subset, generate a second indicator corresponding to the number of end users impacted by a first type of software bug.

11. The method of claim 9, wherein a first number of product information messages are associated with the first type of software bug and a second number of unstructured feedback messages are associated with the first type of software bug.

12. The method of claim 9, wherein an impact indicator that corresponds to the number of end users impacted by the new type of software bug is generated based on the first number and the second number.

13. The method of claim 9, wherein an impact indicator that corresponds to the number of end users impacted by the new type of software bug is generated based on the first number, the second number, and a third number corresponding to an instance count.

14. The method of claim 13, wherein the unstructured feedback messages received via social media.

15. A non-transitory computer readable medium having instructions stored thereon for identifying the impact of software bugs that, when executed by a computer, at least instruct the computer to:
receive product information messages generated by instances of a software product, the product information messages including indicators used to associate each of the product information messages with at least one of plurality of types of software bugs, the plurality of types of software bugs including a first type of software bug;
receive unstructured feedback messages from users of the software product;
based on the unstructured feedback messages, generate respective structured feedback indicators;
map, based on respective structured feedback indicators, a first subset of the unstructured feedback messages to respective ones of the plurality of types of software bugs;
determine, based on respective structured feedback indicators, a second subset of the unstructured feedback messages is not mapped to respective ones of the plurality of types of software bugs; and,
based on the first subset and the second subset, generate a first indicator corresponding to the number of end users impacted by a second type of software bug that is not one of the plurality of types of software bugs.

16. The computer readable medium of claim 1, wherein the computer is further instructed to:
based on the first subset, generate a second indicator corresponding to the number of end users impacted by the first type of software bug.

17. The computer readable medium of claim 15, wherein a first number of product information messages are associated with the first type of software bug and a second number of unstructured feedback messages are associated with the first type of software bug.

18. The computer readable medium of claim 17, wherein an impact indicator that corresponds to the number of end users impacted by the first type of software bug is generated based on the first number and the second number.

19. The computer readable medium of claim 15, wherein the structured feedback indicators comprise verb-noun pairs that are associated to one of a set of bug types comprising the plurality of types of software bugs and the second type of software bug.

20. The computer readable medium of claim 1, wherein the computer is further instructed to:
obtain, from a social media source, the unstructured feedback messages.
